(19) United States
(12) Patent Application Publication
(10) Pub. No.: US 2026/0180982 A1
(43) Pub. Date: Jun. 25, 2026

(54) MULTIFACTOR AUTHENTICATION USING NETWORK ADDRESS TRANSLATION DATA

(71) Applicant: AT&T Intellectual Property I, L.P., Atlanta, GA (US)

(72) Inventors: Jessica Dill, Coweta, OK (US); Dena Towells, Atlanta, GA (US); Dexter Hansraj, Woodstock, GA (US); Jitendra Patel, Dardenne Prairie, MO (US)

(21) Appl. No.: 18/991,682

(22) Filed: Dec. 22, 2024

(51) Int. Cl. H04L 9/40

(52) U.S. Cl. CPC H04L 63/0876; H04L 63/10

(57) ABSTRACT

The present disclosure describes a device, computer-readable medium, and method for multifactor authentication using network address translation data. A method performed by a processing system includes receiving, from a host device in a communication network, a request to authenticate a user, wherein the request includes a purported identity of the user and a public internet protocol address assigned to a user endpoint device from which a request to access a resource at the host device was sent, querying a provider edge server for a verification that the purported identity matches an identity associated with a private internet protocol address that is mapped to the public internet protocol address, receiving a first response from the provider edge server, determining whether to authenticate the user based on the first response from the provider edge server, and sending a second response to the host device indicating a result of the determining.

The present disclosure relates generally to digital privacy, and relates more particularly to devices, non-transitory computer-readable media, and methods for multifactor authentication using network address translation data.

### BACKGROUND

Multifactor authentication (MFA) is a digital security method that requires a user to provide more than one way to verify his or her identity to gain access to a resource (e.g., an account or service). As an example, a user may initiate a login to an account using his or her email address and a password. In response, an MFA system may send a personal identification number (PIN) or code to a known device (e.g., a mobile phone) of the user and ask the user to input the PIN or code back into the account. If the PIN or code entered by the user matches the PIN or code sent to the known device, then the user is allowed to access the account. Other forms of multifactor authentication include authentication applications that prompt a user to confirm he or she is currently attempting to log into an account, security questions having answers that are predefined by the user, biometric data (e.g., fingerprint, face or retina scan) of the user, or network usage patterns (e.g., typical Internet Protocol address range, location, or the like), among others.

### SUMMARY

In one example, the present disclosure describes a device, computer-readable medium, and method multifactor authentication using network address translation data. For instance, in one example, a method performed by a processing system including at least one processor includes receiving, from a host device in a communication network, a request to authenticate a user, wherein the request includes a purported identity of the user and a public internet protocol address assigned to a user endpoint device from which a request to access a resource at the host device was sent, querying a provider edge server for verification that the purported identity matches an identity associated with a private internet protocol address that is mapped to the public internet protocol address, receiving a first response from the provider edge server, determining whether to authenticate the user based on the first response from the provider edge server, and sending a second response to the host device indicating a result of the determining.

In another example, a non-transitory computer-readable medium stores instructions which, when executed by a processing system including at least one processor, cause the processing system to perform operations. The operations include receiving, from a host device in a communication network, a request to authenticate a user, wherein the request includes a purported identity of the user and a public internet protocol address assigned to a user endpoint device from which a request to access a resource at the host device was sent, querying a provider edge server for verification that the purported identity matches an identity associated with a private internet protocol address that is mapped to the public internet protocol address, receiving a first response from the provider edge server, determining whether to authenticate the user based on the first response from the provider edge server, and sending a second response to the host device indicating a result of the determining.

In another example, a system includes a processing system including at least one processor and a non-transitory computer-readable medium storing instructions which, when executed by the processing system, cause the processing system to perform operations. The operations include receiving, from a host device in a communication network, a request to authenticate a user, wherein the request includes a purported identity of the user and a public internet protocol address assigned to a user endpoint device from which a request to access a resource at the host device was sent, querying a provider edge server for verification that the purported identity matches an identity associated with a private internet protocol address that is mapped to the public internet protocol address, receiving a first response from the provider edge server, determining whether to authenticate the user based on the first response from the provider edge server, and sending a second response to the host device indicating a result of the determining.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for multifactor authentication using network address translation data may operate;

FIG. 2 illustrates a flowchart of an example method for multifactor authentication using network address translation data, according to the present disclosure;

FIG. 3 illustrates a flowchart of an example method for multifactor authentication using network address translation data, according to the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for multifactor authentication using network address translation data. As discussed above, multifactor authentication (MFA) is a digital security method that requires a user to provide more than one way to verify his or her identity to gain access to a resource (e.g., an account or service). As an example, a user may initiate a login to an account using his or her email address and a password. In response, an MFA system may send a personal identification number (PIN) or code to a known device (e.g., a mobile phone) of the user and ask the user to input the PIN or code back into the account. If the PIN or code entered by the user matches the PIN or code sent to the known device, then the user is allowed to access the account. Other forms of multifactor authentication include authentication applications that prompt a user to confirm he or she is currently attempting to log into an account, security questions having answers that are predefined by the user, biometric data (e.g., fingerprint, face or retina scan) of the user, or network usage patterns (e.g., typical Internet Protocol address range, location, or the like), among others.

Most conventional MFA techniques require the user who is attempting to access the resource to provide some additional information or perform some additional actions beyond inputting his or her login information. For instance, as discussed above, the user may be asked to answer a security question, provide a fingerprint, or interact with an authentication application. These additional steps may be cumbersome for the user and foster dissatisfaction with the user experience. For instance, users frequently report that conventional MFA techniques are too complicated (e.g., require too many steps that are not intuitive), too time-consuming (e.g., long enough to negatively impact productivity), prone to too many technical issues (e.g., delayed short messaging service codes, malfunctioning authentication applications, inconsistent biometric recognition, etc.), or lack accessibility (e.g., are not fully usable by users with disabilities). Many users also simply experience fatigue as a result of repeated authentication requests, which may cause some users to seek workarounds that bypass MFA and compromise security.

Furthermore, even some of the best MFA techniques are not foolproof. It is still possible for an unauthorized user to gain access to information used to perform MFA, such as PINs, codes, and answers to security questions, through techniques including phishing, social engineering, subscriber identity module (SIM) swapping, and the like. For instance, an unauthorized user may trick an authorized user into providing PINs or codes through carefully crafted emails or text messages, or may determine the answer to a security question by mining the authorized user's social media accounts.

Examples of the present disclosure use network address translation (NAT) information to perform MFA in a secure manner that requires little to no further action from the user. NAT is a technique performed by an Internet service provider (ISP) that translates a private Internet Protocol (IP) address of a user endpoint device into a public IP address that is shared with any other devices or hosts that the user endpoint device connects to via the network. In particular, a provider edge router of the ISP intercepts packets sent by the user endpoint device and replaces the private IP address in the headers of the packets with the public IP address; thus, any recipient of the packets will see the public IP address rather than the private IP address. NAT was developed to conserve global IP address space, but may be leveraged in the context of MFA to provide seamless and secure authentication.

In particular, when a user attempts to connect to a remote host via the Internet (e.g., by logging into a website, an application, or the like, which may be hosted on a server), the remote host may query the ISP. The query may provide the public IP address of the user (as extracted from the header of one or more data packets associated with the user's connection attempt) and ask the ISP to verify that the purported user identity associated with the public IP address matches the user identity associated with the private IP address that is mapped to the public IP address. If the identities match, then the user may be authenticated to the remote host.

Since the disclosed MFA technique is handled entirely by the network infrastructure, the process is largely transparent to users. That is, the users do not see the operations being performed and do not need to perform any additional actions, which improves the user experience. Moreover, because the mapping between private IP address and public IP address is known only to the ISP and to no other party, this provides resiliency against commonly used avenues by which unauthorized users might attempt to compromise MFA.

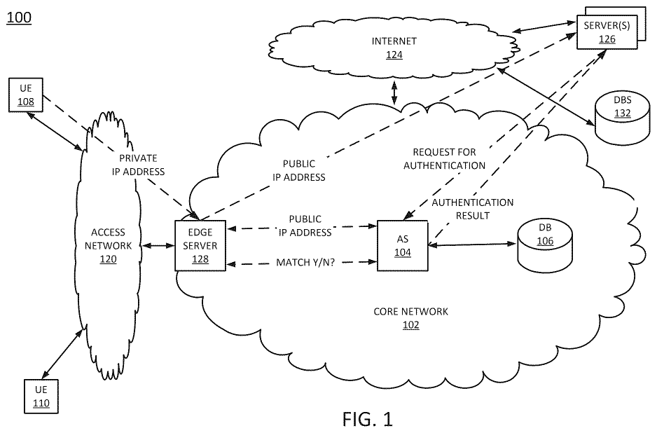

Further examples of the present may employ the Diameter protocol to ensure scalability of the solution to larger numbers of authentication requests. These and other aspects of the present disclosure are discussed in further detail with reference to FIGS. 1-4, below.

To further aid in understanding the present disclosure, FIG. 1 illustrates an example system 100 in which examples of the present disclosure for multifactor authentication using network address translation data may operate. The system 100 may include any one or more types of communication networks, such as a traditional circuit switched network (e.g., a public switched telephone network (PSTN)) or a packet network such as an IP network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks such as access network 120 and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include a plurality of network elements, including at least an application server (AS) 104 (e.g., an authentication server) and a database (DB) 106. Additionally, the core network 102 may include a plurality of edge servers, including edge server 128. For ease of illustration, various additional elements of the core network 102 are omitted from FIG. 1.

In one example, the access network 120 may comprise a Digital Subscriber Line (DSL) network, a public switched telephone network (PSTN) access network, a broadband cable access network, a Local Area Network (LAN), a wireless access (e.g., an IEEE 802.11/Wi-Fi network and the like), a cellular access network, a 3^{rd} party network, and the like. For example, the operator of the core network 102 may provide a cable television service, an IPTV service, a streaming service, or any other types of telecommunication services to subscribers via access network 120. In one example, the core network 102 may be operated by a telecommunication network service provider (e.g., an Internet service provider, or a service provider who provides Internet services in addition to other telecommunication services). The core network 102 and the access network 120 may be operated by different service providers, the same service provider or a combination thereof, or the access network 120 may be operated by an entity having core businesses that are not related to telecommunications services, e.g., corporate, governmental, or educational institution LANs, and the like.

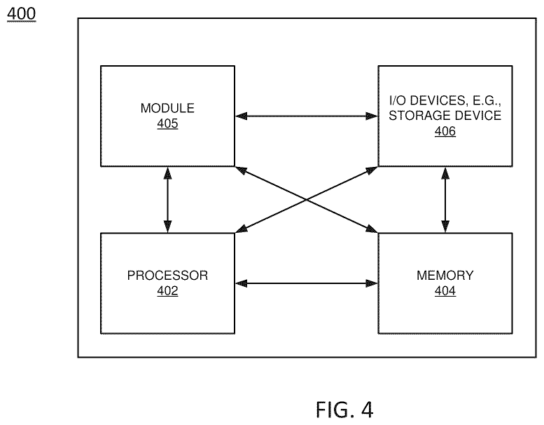

In one example, the access network 120 may be in communication with one or more user endpoint devices (UEs) 108 and 110. The access network 120 may transmit and receive communications between the user endpoint devices 108 and 110, between the user endpoint devices 108 and 110, server(s) 126 (e.g., host devices for applications, services, and resources), other components of the core network 102, devices reachable via the Internet in general, and so forth. In one example, each of the user endpoint devices 108 and 110 may comprise any single device or combination of devices that may comprise a user endpoint device, such as computing system 400 depicted in FIG. 4, and may be configured as described below. For example, the user endpoint devices 108 and 110 may each comprise a mobile device, a cellular smart phone, a gaming console, a set top box, a laptop computer, a tablet computer, a desktop computer, an application server, a wearable device (e.g., a smart watch or fitness tracker), an augmented reality (AR)/ virtual reality (VR) headset, customer premises equipment (e.g., gateway devices), a bank or cluster of such devices, and the like.

In one example, one or more servers 126 and one or more databases 132 may be accessible to user endpoint devices 108 and 110 via Internet 124 in general. The server(s) 126 and DBs 132 may be associated with various resources such as software applications, services, computing resources, and the like. The server(s) 126 and DBs 132 may exchange data related to these resources with the user endpoint devices 108 and 110 over the Internet 124. Thus, some of the server(s) 126 and DBs 132 may host applications including video conferencing applications, extended reality (e.g., virtual reality, augmented reality, mixed reality, and the like) applications, streaming media applications, social networking applications, immersive gaming applications, and the like. At least some of the applications may restrict access to authorized users and may require MFA in order to verify that a user attempting to access an application is an authorized user.

In accordance with the present disclosure, the AS 104 and edge server 128 may be collectively configured to provide one or more operations or functions in connection with examples of the present disclosure for multifactor authentication using network address translation data, as described herein. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the edger server 128 may be configured to perform NAT, as discussed above. For instance, when a user endpoint device such as user endpoint 108 attempts to access a resource hosted by a server 126, data packets associated with the request, which include the private IP address of the user endpoint device 108 in their headers, may be intercepted by the edge server 128. The edge server 128 may replace the private IP address in the headers of the data packets with a public IP address that is mapped to the private IP address, before forwarding the data packets to the server 126.

When the server 126 receives the data packets, the server may extract a purported user identity (e.g., a name, a user identifier, a password, and/or the like) from the payloads of the data packets, as well as the public IP address from the headers of the data packets. The server 126 may send the purported user identity and the public IP address in an authentication request to the AS 104, which may function as an authentication server.

The AS 104 may send the public IP address and the purported user identity to the edge server 128 and may ask the edge server 128 to confirm whether the private IP address that is mapped to the public IP address is associated with a user identity that matches the purported user identity. If the edger server 128 confirms the match, then the AS 104 may indicate a successful authentication to the server 126 in an authentication result. However, if edger server 128 does not confirm the match, then the AS 104 may indicate a failed authentication to the server 126 in the authentication result. The AS 104 may store records of authentication requests (including results of those requests) in the DB 106.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access network 120, and/or Internet 124 may comprise a content distribution network (CDN) having ingest servers, edge servers, and the like. Similarly, although only one access network 120 is shown, in other examples, access network 120 may comprise a plurality of different access networks that may interface with the core network 102 independently or in a chained manner. For example, UE devices 108 and 110 may communicate with the core network 102 via different access networks. Thus, these and other modifications are all contemplated within the scope of the present disclosure.

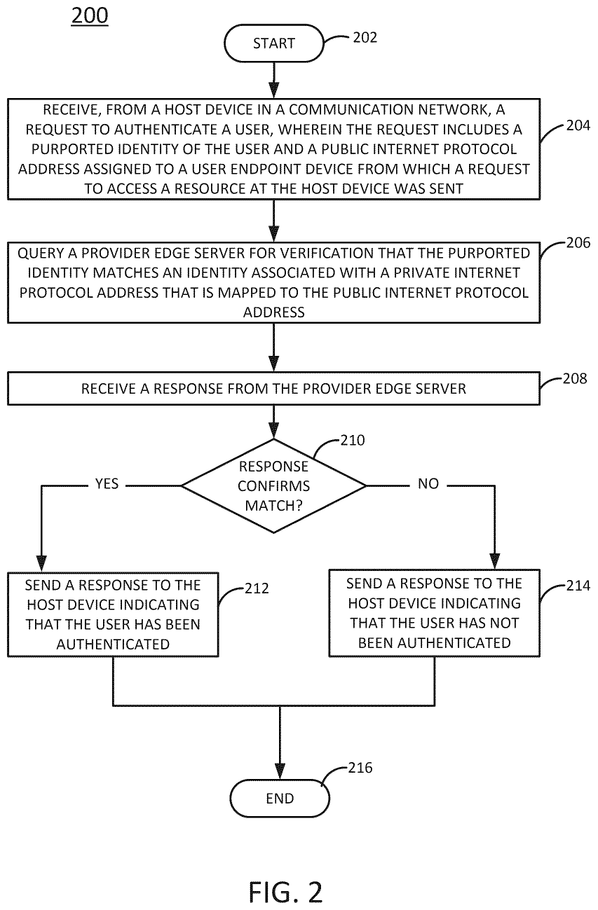

FIG. 2 illustrates a flowchart of an example method 200 for multifactor authentication using network address translation data. In one example, the method 200 may be performed by the authentication server 104 illustrated in FIG. 1 or one or more components thereof. However, in other examples, the method 200 may be performed by another device, such as the computing system 400 of FIG. 4, discussed in further detail below. For the sake of discussion, the method 200 is described below as being performed by a processing system (where the processing system may comprise a component of the authentication server 104, the computing system 400, or another device).

The method 200 begins in step 202. In step 204, the processing system may receive, from a host device in a communication network, a request to authenticate a user, wherein the request includes a purported identity of the user and a public Internet Protocol address assigned to a user endpoint device from which a request to access a resource at the host was sent.

In one example, the host device may comprise a device (e.g., a server, a virtual network function, or the like) that hosts or otherwise supports the resource. The resource may comprise, for example, a software application (e.g., a social networking application, a business application, or the like), a service (e.g., a media streaming service, a banking service, or the like), a computing resource (e.g., a virtual private network), or the like.

The user may request the access to the resource by providing a set of credentials to the host device, where the set of credentials uniquely identifies the user. The set of credentials may be provided in the payload(s) of one or more data (e.g., IP) packets sent from the user endpoint device to the host device and extracted from the one or more data packets by the host device. In one example, the set of credentials may comprise one or more of: a user identifier (e.g., a name, a nickname, or the like, such as “Jane Doe” or “JDoe123”), an email address (e.g., “jane.doe@email.com”), or a password. Thus, in one example, the purported identity may be the user identity (e.g., “Jane Doe”) that is associated with the set of credentials provided to the host device.

In one example, the public IP address may be extracted from the header(s) of the one or more data packets sent by the user endpoint device to the host device.

In step 206, the processing system may query a provider edge server for verification that the purported identity matches an identity associated with a private Internet Protocol address that is mapped to the public Internet Protocol address.

In one example, the provider edge server may comprise a server that performs NAT. Thus, the provider edge server may have intercepted the one or more data packets sent by the user endpoint device to the host device. The provider edge server may have replaced the private IP address contained in the header(s) of the one or more data packets with the public IP address that is mapped to the private IP address, prior to the one or more data packets being received by the host device.

A private IP address is unique within a local network, so that the private IP address is assigned to only one user endpoint device in the local network. That one user endpoint device may further be associated with one or more specific user identities. Thus, if it can be confirmed that the user identity associated with the private IP address to which the public IP address is mapped matches the purported identity, then it can be confirmed that the user who is attempting to access the resource is who he or she is claiming to be.

In step 208, the processing system may receive a response from the provider edge server. In one example, the response from the provider edge server may indicate either: (1) that the purported identity matches the identity associated with the private IP address (e.g., the user is authenticated); or (2) that the purported identity does not matches the identity associated with the private IP address (e.g., the user is not authenticated). The provider edge server, as discussed above, is in a unique position to verify the match since the provider edge server is the only device with access to the mappings between private and public IP addresses.

In one example, the provider edge server may not provide the private IP address to the processing system in the response, but may merely verify the match. In another example, however, the provider edge may provide a pairing of the public IP address and mapped private IP address to the processing system (e.g., using the Diameter protocol to ensure the security of the pairing data).

In step 210, the processing system may determine whether the response confirms that the purported identity matches the identity associated with the private Internet Protocol address.

As discussed above, the response may indicate one of two possibilities, and the processing system determines which of those two possibilities is indicated in the response. For instance, the response may include a message that says “MATCH” or “NO MATCH” or ‘AUTHENTICATION SUCCESSFUL” or “AUTHENTICATION FAILED.”

If the processing system concludes in step 210 that the response confirms that the purported identity matches the identity associated with the private Internet Protocol address, then the method 200 may proceed to step 212. In step 212, the processing system may send a response to the host device indicating that the user has been authenticated.

In one example, the response to the host device may further instruct the host device to grant access to the resource to (e.g., to establish a connection to) the user endpoint device.

If, on the other hand, the processing system concludes in step 210 that the response does not confirm that the purported identity matches the identity associated with the private Internet Protocol address, then the method 200 may proceed to step 214. In step 214, the processing system may send a response to the host device indicating that the user has not been authenticated.

In one example, the response to the host device may further instruct the host device to deny access to the resource to (e.g., to reject a connection to) the user endpoint device. In a further example, the response to the host device may further instruct the host device to seek an alternate form of multifactor authentication from the user.

Once the processing system has sent an appropriate response to the host device in accordance with either step 212 or step 214, the method 200 may end in step 216.

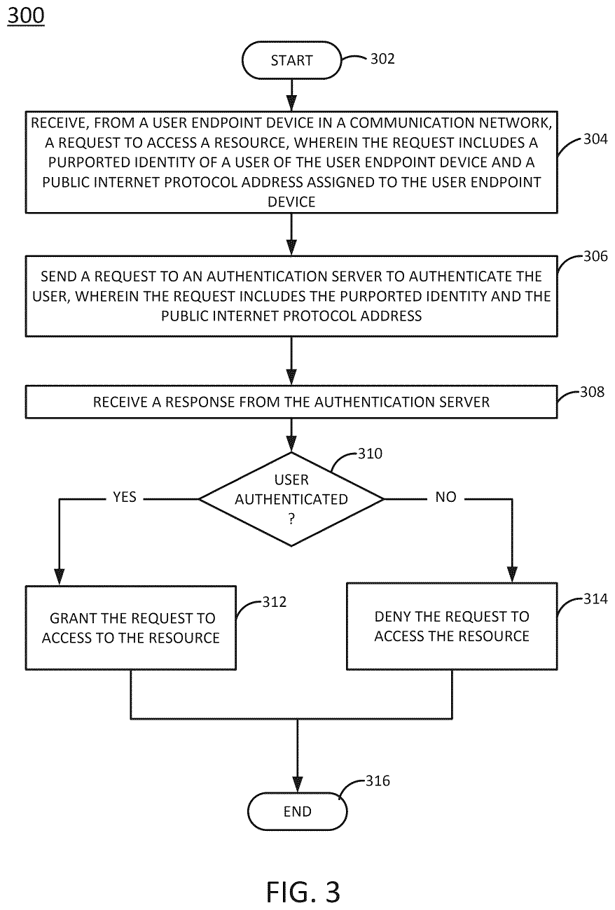

FIG. 3 illustrates a flowchart of an example method 300 for multifactor authentication using network address translation data. In one example, the method 300 may be performed by the server 126 illustrated in FIG. 1 functioning as a host device or one or more components thereof. However, in other examples, the method 300 may be performed by another device, such as the computing system 400 of FIG. 4, discussed in further detail below. For the sake of discussion, the method 300 is described below as being performed by a processing system (where the processing system may comprise a component of the servers 126, the computing system 400, or another device).

The method 300 begins in step 302. In step 304, the processing system may receive, from a user endpoint device in a communication network, a request to access a resource, wherein the request includes a purported identity of a user of the user endpoint device and a public Internet Protocol address assigned to the user endpoint device.

In one example, the processing system may be part of a host device (e.g., a server, a virtual network function, or the like) that hosts or otherwise supports the resource. The resource may comprise, for example, a software application (e.g., a business application), a service (e.g., a media streaming service, a banking service, or the like), a computing resource (e.g., a virtual private network), or the like.

The user may request the access to the resource by providing a set of credentials to the processing system, where the set of credentials uniquely identifies the user. The set of credentials may be provided in the payload(s) of one or more data (e.g., IP) packets sent from the user endpoint device to the processing system and extracted from the one or more data packets by the processing system. In one example, the set of credentials may comprise one or more of: a user identifier (e.g., a name, a nickname, or the like, such as “Jane Doe” or “JDoe123”), an email address (e.g., “jane.doe@email.com”), or a password. Thus, in one example, the purported identity may be the user identity (e.g., “Jane Doe”) that is associated with the set of credentials provided to the processing system.

In one example, the public IP address may be extracted from the header(s) of the one or more data packets sent by the user endpoint device to the processing system.

In step 306, the processing system may send a request to an authentication server to authenticate the user, wherein the request includes the purported identity and the public Internet Protocol address.

In one example, authentication server may be a server that handles authentication requests in the communication network. The authentication server may handle the authentication requests in cooperation with a provider edge server that performs NAT. Thus, the provider edge server may have intercepted the one or more data packets sent by the user endpoint device to the processing system. The provider edge server may have replaced the private IP address contained in the header(s) of the one or more data packets with the public IP address that is mapped to the private IP address, prior to the one or more data packets being received by the host device.

In step 308, the processing system may receive a response from the authentication server.

In one example, the response may indicate one of two possibilities, and the processing system determines which of those two possibilities is indicated in the response. For instance, the response may include a message that says “MATCH” or “NO MATCH,” or ‘AUTHENTICATION SUCCESSFUL” or “AUTHENTICATION FAILED.”

In step 310, the processing system may determine whether the response indicates that the user has been authenticated.

For instance, the processing system may determine whether the response indicates “MATCH” or “NO MATCH,” or ‘AUTHENTICATION SUCCESSFUL” or “AUTHENTICATION FAILED.”

If the processing system concludes in step 310 that the response confirms that the user has been authenticated, then the method 300 may proceed to step 312. In step 312, the processing system may grant the request to access the resource.

In one example, granting the request may comprise completing a login process for the user that was started when the user provided the set of credentials to the processing system. Granting the access to the resource may involve establishing a connection to the user endpoint device.

If, on the other hand, the processing system concludes in step 310 that the response does not confirm that the user has been authenticated, then the method 300 may proceed to step 314. In step 314, the processing system may deny the request to access the resource.

In one example, denying the request may comprise terminating a login process for the user that was started when the user provided the set of credentials to the processing system. Thus, the processing system may decline to establish a connection to the user endpoint device. In a further example, the processing system further instruct the user to retry the request for access (either immediately or at a later time) or to provide data for an alternate form of multifactor authentication (e.g., a password, code, or the like).

Once the processing system has either granted (e.g., in accordance with step 312) or denied (e.g., in accordance with step 314) the request to access the resource, the method 300 may end in step 316.

Although not expressly specified above, one or more steps of the method 200 or method 300 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

Thus, examples of the present disclosure use network address translation (NAT) information to perform MFA in a secure manner that requires little to no further action from the user, which improves the user experience. Moreover, because the mapping between private IP address and public IP address is known only to the ISP and to no other party, this eliminates many potential avenues by which unauthorized users might attempt to compromise MFA.

In further examples, examples of the present disclosure may be used to create a “black zone” or segment of the communication network that is highly restricted and secured to protect sensitive or critical data against unauthorized access. For instance, when a user attempts to access a resource via the communications network, the user's endpoint device may first access the communication network via a local public WiFi network (e.g., a WiFi network associated with a private business, home, or school) rather than via a cellular base station. In this case, the NAT mapping from private to public IP address may be different for access via the base station and access via the local public WiFi. This different mapping may be detected, alerting the authentication server to the fact that the user is attempting to access the resource from a location that is potentially not secure (e.g., potentially susceptible to main-in-the-middle or other forms of attack). In this case, the authentication server may instruct the host device to tell the user to re-attempt the request for access from a secure network.

FIG. 4 depicts a high-level block diagram of a computing device specifically programmed to perform the functions described herein. For example, any one or more components or devices illustrated in FIG. 1 or described in connection with the method 200 or the method 300 may be implemented as the system 400. For instance, the authentication server 104 of FIG. 1 (such as might be used to perform the method 200) could be implemented as illustrated in FIG. 4. In another example, the server(s) 126 of FIG. 1 (such as might be used to perform the method 300) could be implemented as illustrated in FIG. 4.

As depicted in FIG. 4, the system 400 comprises a hardware processor element 402, a memory 404, a module 405 for multifactor authentication using network address translation data, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for multifactor authentication using network address translation data may include circuitry and/or logic for performing special purpose functions relating to extracting user identities and/or device IP addresses from data packets and granting or denying access to resources. The input/output devices 406 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the specific-purpose computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a specific purpose computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for multifactor authentication using network address translation data (e.g., a software program comprising computer-executable instructions) can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for multifactor authentication using network address translation data (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
receiving, from a host device in a communication network by a processing system including at least one processor, a request to authenticate a user, wherein the request includes a purported identity of the user and a public internet protocol address assigned to a user endpoint device from which a request to access a resource at the host device was sent;
querying, by the processing system, a provider edge server for a verification that the purported identity matches an identity associated with a private internet protocol address that is mapped to the public internet protocol address;
receiving, by the processing system, a first response from the provider edge server;
determining, by the processing system, whether to authenticate the user based on the first response from the provider edge server; and
sending, by the processing system, a second response to the host device indicating a result of the determining.

2. The method of claim 1, wherein the processing system is part of an authentication server provided by an operator of at least a portion of the communication network.

3. The method of claim 1, wherein the host device comprises a device that hosts the resource.

4. The method of claim 1, wherein the resource comprises at least one of: a software application, a service, or a computing resource.

5. The method of claim 1, wherein the purported identity is determined from a set of credentials extracted from a payload of a data packet associated with the request to access the resource.

6. The method of claim 5, wherein the set of credentials comprises at least one of: a user identifier, an email address, or a password.

7. The method of claim 5, wherein the public internet protocol address is extracted from a header of the data packet.

8. The method of claim 7, wherein the provider edge server replaced a private internet protocol address contained in the header with the public internet protocol address prior to forwarding the data packet to the host device.

9. The method of claim 1, wherein the determining comprises determining to authenticate the user when the first response from the provider edge server indicates that the purported identity matches the identity associated with the private internet protocol address that is mapped to the public internet protocol address.

10. The method of claim 9, wherein the second response to the host device indicates that the user has been authenticated.

11. The method of claim 1, wherein the determining comprises determining not to authenticate the user when the first response from the provider edge server indicates that the purported identity does not match the identity associated with the private internet protocol address that is mapped to the public internet protocol address.

12. The method of claim 11, wherein the second response to the host device indicates that the user has not been authenticated.

13. The method of claim 1, wherein the receiving the request, the querying, the receiving the first response from the provider edge server, the determining, and the sending the second response to the host device are performed without requiring further input from the user.

14. A non-transitory computer-readable medium storing instructions which, when executed by a processing system including at least one processor, cause the processing system to perform operations, the operations comprising:
receiving, from a host device in a communication network, a request to authenticate a user, wherein the request includes a purported identity of the user and a public internet protocol address assigned to a user endpoint device from which a request to access a resource at the host device was sent;
querying a provider edge server for a verification that the purported identity matches an identity associated with a private internet protocol address that is mapped to the public internet protocol address;
receiving a first response from the provider edge server;
determining whether to authenticate the user based on the first response from the provider edge server; and
sending a second response to the host device indicating a result of the determining.

15. The non-transitory computer-readable medium of claim 14, wherein the determining comprises determining to authenticate the user when the first response from the provider edge server indicates that the purported identity matches the identity associated with the private internet protocol address that is mapped to the public internet protocol address.

16. The non-transitory computer-readable medium of claim 15, wherein the second response to the host device indicates that the user has been authenticated.

17. The non-transitory computer-readable medium of claim 14, wherein the determining comprises determining not to authenticate the user when the first response from the provider edge server indicates that the purported identity does not match the identity associated with the private internet protocol address that is mapped to the public internet protocol address.

18. The non-transitory computer-readable medium of claim 17, wherein the second response to the host device indicates that the user has not been authenticated.

19. The non-transitory computer-readable medium of claim 14, wherein the receiving the request, the querying, the receiving the first response from the provider edge server, the determining, and the sending the second response to the host device are performed without requiring further input from the user.

20. A system comprising:
a processing system including at least one processor; and
a non-transitory computer-readable medium storing instructions which, when executed by the processing system, cause the processing system to perform operations, the operations comprising:
receiving, from a host device in a communication network, a request to authenticate a user, wherein the request includes a purported identity of the user and a public internet protocol address assigned to a user endpoint device from which a request to access a resource at the host device was sent;
querying a provider edge server for a verification that the purported identity matches an identity associated with a private internet protocol address that is mapped to the public internet protocol address;
receiving a first response from the provider edge server;
determining whether to authenticate the user based on the first response from the provider edge server; and
sending a second response to the host device indicating a result of the determining.
